(19) United States
(12) Patent Application Publication
(10) Pub. No.: US 2026/0281572 A1
(43) Pub. Date: Sep. 17, 2026

(54) EVENT DETECTION PIXEL SENSOR CIRCUIT ASSEMBLY

(71) Applicant: University of Tennessee Research Foundation, Knoxville, TN (US)

(72) Inventors: Ahmedullah Aziz, Knoxville, TN (US); Md Rahatul Islam Udoy, Knoxville, TN (US)

(21) Appl. No.: 19/554,971

(22) Filed: Mar. 3, 2026

Related U.S. Application Data
(60) Provisional application No. 63/766,122, filed on Mar. 3, 2025.

(51) Int. Cl. H04N 25/47; H04N 25/77

(52) U.S. Cl. CPC H04N 25/47; H04N 25/77

(57) ABSTRACT

An event detection pixel sensor circuit assembly for employment in image sensors utilized in automotive, aerospace, medical, robotics, industrial, civilian, and military applications, among many other possibilities. The event detection pixel sensor circuit assembly, per an implementation, includes a multitude of transistors, a cross-coupled inverter, and an exclusive OR (XOR) logic gate circuit assembly. One of the multitude of transistors is a hybrid phase transition field-effect transistor (HyperFET) with a phase transition material (PTM). Amid operation of the event detection pixel sensor circuit assembly, the phase transition material switches states in response to incident light levels (e.g., high, low) at a photodiode of the event detection pixel sensor circuit assembly.

### CROSS-REFERENCE TO RELATED APPLICATION

This application claims the benefit of U.S. Provisional Patent Application No. 63/766,122, with a filing date of Mar. 3, 2025, the contents of which are hereby incorporated by reference in their entirety.

### TECHNICAL FIELD

The present disclosure relates generally to image sensors and, more particularly, to pixel circuit configurations employed in image sensors.

### BACKGROUND

Image sensors are semiconductor devices that convert optical images into digital signals. An event detection pixel sensor is a type of image sensor that, in general, only captures changes in a scene by detecting variations in local illumination and light levels and intensities at each of its associated pixels. Event detection can enable high-speed, low-power, and low-latency imaging capabilities that are often important in applications in which rapid response to dynamic scenes is paramount. Applications of use include high-speed motion tracking, gesture recognition, surveillance and security, autonomous vehicles, robotics, drone navigation, industrial inspection, and augmented and virtual reality (AR/VR) implementations, among many other possibilities. Moreover, fields in which event detection can be useful include, but are not limited to, automotive, aerospace, medical, robotics, civilian, and military fields. Past event detection pixel sensors commonly employed the use of comparators. But due to the relatively large size of the comparators—and because all pixels were transmitted for downstream processing—these past event detection pixel sensors have been observed to suffer from slower overall execution and sequential processing, among other shortcomings.

### SUMMARY

In an embodiment, an event detection pixel sensor circuit assembly for an image sensor may include a reset transistor, a first transistor, a second transistor, a cross-coupled inverter, and an exclusive OR (XOR) logic gate circuit assembly. The reset and first and second transistors are in electrical communication and coupling with one another. The first transistor is a hybrid phase transition field-effect transistor (HyperFET) with a phase transition material (PTM) at a source terminal thereof. The cross-coupled inverter is in downstream electrical communication and coupling with the first and second transistors. The XOR logic gate circuit assembly is in electrical communication and coupling with the cross-coupled inverter. During operation of the event detection pixel sensor circuit assembly, a state of the phase transition material of the hybrid phase transition field-effect transistor switches when a photodiode voltage of a photodiode of the event detection pixel sensor circuit assembly is lesser in value than a threshold photodiode voltage due to an incident light level at the photodiode.

In an embodiment, an event detection pixel sensor circuit assembly for an image sensor may include a binary pixel sensor circuit assembly, a cross-coupled inverter, and a complementary metal-oxide-semiconductor (CMOS) exclusive OR (XOR) logic gate circuit assembly. The binary pixel sensor circuit assembly includes a reset transistor, a first transistor, and a second transistor in electrical communication and coupling with one another. The first transistor is a hybrid phase transition field-effect transistor (HyperFET) with a phase transition material (PTM) at a source terminal thereof. The cross-coupled inverter is in electrical communication and coupling with the binary pixel sensor circuit assembly. The CMOS XOR logic gate circuit assembly is in electrical communication and coupling with the cross-coupled inverter. During operation of the event pixel sensor circuit assembly, a current pixel voltage value is received by the cross-coupled inverter and a previous pixel voltage value is stored by the cross-coupled inverter. The current pixel voltage value is compared to the previous pixel voltage value by way of the CMOS XOR logic gate circuit assembly. When the current pixel voltage value and the previous pixel voltage value lack correspondence with respect to each other (i.e., an absence of matching therebetween), an output of the CMOS XOR logic gate circuit assembly establishes and indicates an event occurrence.

In an embodiment, an event detection pixel sensor circuit assembly for an image sensor may include a reset transistor, a first transistor, a second transistor, a cross-coupled inverter, an exclusive OR (XOR) logic gate circuit assembly, and a transfer transistor. The reset and first and second transistors are in electrical communication and coupling with one another. The first transistor is a hybrid phase transition field-effect transistor (HyperFET) with a phase transition material (PTM) at a source terminal thereof. The cross-coupled inverter is in electrical communication and coupling with the first and second transistors. The XOR logic gate circuit assembly is in electrical communication and coupling with the cross-coupled inverter. The transfer transistor is in electrical communication and coupling with the cross-coupled inverter. During operation of the event pixel sensor circuit assembly, a current pixel voltage value is transferred to the cross-coupled inverter by way of the transfer transistor, and a previous pixel voltage value is stored by the cross-coupled inverter. The current pixel voltage value is compared to the previous pixel voltage value by way of the XOR logic gate circuit assembly. When the current pixel voltage value and the previous pixel voltage value lack correspondence with respect to each other (i.e., an absence of matching therebetween), an output of the XOR logic gate circuit assembly establishes and indicates an event occurrence. Further, during operation of the event pixel sensor circuit assembly, an integration time period of a light integration phase of the event detection pixel sensor circuit assembly can be varied with respect to a photodiode voltage of a photodiode of the event detection pixel sensor circuit assembly, while a threshold photodiode voltage remains substantially constant.

Further scope of applicability of the present disclosure will become apparent from the detailed description given hereinafter. But it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a schematic depiction of an embodiment of a camera and an image sensor having a pixel circuit;

FIG. 2 is a schematic demonstration of transmissions between a past pixel array (denoted “Regular Pixel Array”) and an associated processor, and between an embodiment of an event detection pixel sensor circuit assembly (denoted “EDPS Array”) and an associated processor;

FIG. 3A is a graph presenting current (I) and voltage (V) characteristics of a VO₂ phase transition material (PTM), with voltage plotted on an x-axis and current plotted on a y-axis;

FIG. 3B is a schematic diagram of a circuit symbol used for the HyperFET;

FIG. 3C is a schematic depiction of an embodiment of a structure of a hybrid phase transition field-effect transistor (HyperFET) having a phase transition material (PTM) at a source terminal thereof;

FIG. 3D is a graph presenting current (I) and voltage (V) characteristics of the HyperFET, with voltage plotted on an x-axis and current plotted on a y-axis;

FIG. 4 is a table (Table I) of simulation parameters of an embodiment of a phase transition material (PTM);

FIG. 5 is a schematic diagram of an embodiment of an event detection pixel sensor circuit assembly;

FIG. 6A is a graph demonstrating variation of insulator resistance (R_{INS}) of a phase transition material (PTM) of a hybrid phase transition field-effect transistor (HyperFET) versus length of the PTM (L_{PTM}) and area of the PTM (A_{PTM}), with area (m²) plotted on an x-axis and length (nm) plotted on a y-axis;

FIG. 6B is a graph presenting critical current (I_{C-IMT}) for an insulator-to-metal transition (IMT) of a phase transition material (PTM) of a hybrid phase transition field-effect transistor (HyperFET) versus area of the PTM (A_{PTM}), with area (m²) plotted on an x-axis and current (μA) plotted on a y-axis;

FIG. 6C is a graph demonstrating a photodiode voltage drop threshold (V_{DD}-V_{Ph,th}) of the event detection pixel sensor circuit assembly versus length of the PTM (L_{PTM}) and area of the PTM (A_{PTM});

FIG. 7 presents graphs depicting five cycles of a timing diagram amid use of the event detection pixel sensor circuit assembly: a first cycle, fourth cycle, and fifth cycle in the graphs show a high incident light level, and a second cycle and third cycle show a low incident light level; all four incident light level transition combinations are illustrated (i.e., high-low, low-low, low-high, and high-high);

FIG. 8 presents graphs demonstrating dynamic tuning capabilities of the event detection pixel sensor circuit assembly by way of varying an integration time period (T_{INT}) of a light integration phase of the event detection pixel sensor circuit assembly;

FIG. 9A is a schematic stick diagram of an embodiment of a stacked configuration of the event detection pixel sensor circuit assembly and larger image sensor, the diagram showing a second tier and layer of the stacked configuration for area estimation (not drawn to scale);

FIG. 9B is a schematic stick diagram of the stacked configuration showing a third tier and layer for area estimation (not drawn to scale);

FIG. 10 is a table (Table II) of area, power, and delay of first, second, and third tiers and layers of FIGS. 9A and 9B;

FIG. 11 presents a Monte Carlo process variation analysis with 10,000 points, with power-delay product (PDP) plotted on a y-axis and pixel indices plotted on an x-axis;

FIG. 12 is a table (Table III) of variation analysis of the Monte Carlo process of FIG. 11; and

FIG. 13 is a table (Table IV) presenting comparison results of an embodiment of the event detection pixel sensor circuit assembly (denoted “This work”) versus certain past event detection pixel sensors (denoted “[4]” and “[1]” and “[5]”).

### DETAILED DESCRIPTION

Referring generally to the drawings, an embodiment of an event detection pixel sensor circuit assembly or configuration 10 is depicted in the figures and described herein. In general, the event detection pixel sensor circuit assembly 10 executes an event detection operation and process amid its use, and is implemented in an image sensor and chip 12. Unlike past event detection pixel sensors, the event detection pixel sensor circuit assembly 10 herein is equipped with a hybrid phase transition field-effect transistor (HyperFET) 14 that has a phase transition material (PTM) 16 in its design and construction, serving to enable an in-pixel event detection module for some or all of the numerous individual pixels 18 in the larger assembly and installation. The abrupt state-switching behavior of the PTM 16 is leveraged in the design and construction and operation of the event detection pixel sensor circuit assembly 10 in order to facilitate efficient thresholding functionality. Comparators located outside of pixels and shared by columns of pixels—largely conventional in past arrangements—are dispensed with in the event detection pixel sensor circuit assembly 10, and hence the associated shortcomings observed in the past arrangements are circumvented. Moreover, according to certain embodiments, the event detection pixel sensor circuit assembly 10 enables dynamic thresholding-decision tunability and variability in a design phase of the event detection pixel sensor circuit assembly 10 and in real-time for effective event detection across diverse incident light levels. Compared to the past arrangements, the event detection pixel sensor circuit assembly 10 is simpler and more compact in design and construction, exhibits an increased processing speed for dynamic imaging, exhibits a decreased power consumption, exhibits enhanced computational efficiencies, and has a lower geometric area; still, other advancements are possible.

Overall, a more effective and efficient event detection pixel sensor circuit assembly is furnished. Applications of use include high-speed motion tracking, gesture recognition, surveillance and security, autonomous vehicles, robotics, drone navigation, industrial inspection, and augmented and virtual reality (AR/VR) implementations, among many other possibilities. And fields in which event detection is useful include, but are not limited to, automotive, aerospace, medical, robotics, civilian, and military fields. Still, a particular embodiment of the event detection pixel sensor circuit assembly 10 may exhibit only one, all, or a combination of, the advancements set forth herein, none of the advancements, or yet other advancements unmentioned.

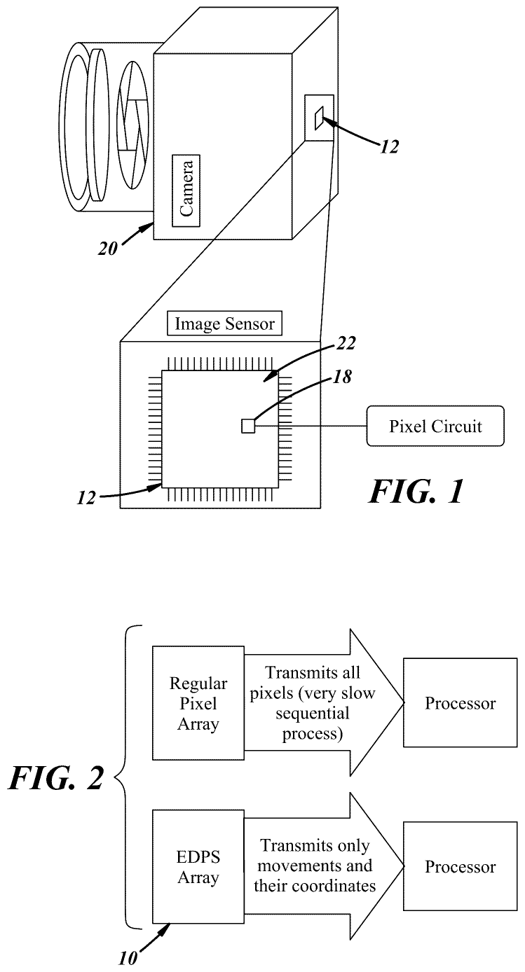

With reference to FIG. 1, an embodiment of the image sensor 12 is presented. The image sensor 12 can be equipped in an event camera 20, per an example implementation. A pixel array 22 of the image sensor 12 is made-up of a multitude of the individual pixels 18 arranged in horizontal rows and vertical columns relative to one another; still, other arrangements of pixels are possible. Each of the pixels 18 can be equipped with a dedicated event detection pixel sensor circuit assembly 10. In this sense, and according to an embodiment, the event detection pixel sensor circuit assembly 10 can be an in-pixel event detection pixel sensor circuit assembly 10. The phrase “in-pixel” is intended to mean that the design, construction, and components of the event detection pixel sensor circuit assembly 10 are incorporated and located within each of the pixels 18. In other words, the in-pixel event detection pixel sensor circuit assembly 10 resides physically within a boundary of its associated and respective pixel 18, and hence the accompanying event detection process is executed within that pixel 18. A pixel-level processing circuit is thereby furnished. All of the pixels 18 in the pixel array 22 can have the in-pixel event detection pixel sensor circuit assembly 10, per an embodiment, or only some of the pixels 18 in the pixel array 22 can have the in-pixel event detection pixel sensor circuit assembly 10. Locating the event detection pixel sensor circuit assembly 10 in-pixel has been shown to partly or more contribute to one or more of the following advancements: i) simpler and more compact design and construction, ii) increased processing speed, iii) low power consumption, iv) enhanced computational efficiencies, and v) decreased geometric area; still, other advancements can arise from the in-pixel location.

With reference now to FIG. 2, it shows a schematic demonstration of transmissions between a past pixel array (denoted “Regular Pixel Array”) and an associated downstream processor, and between an embodiment of the event detection pixel sensor circuit assembly 10 (denoted “EDPS Array”) and an associated downstream processor. The past pixel array is shown to transmit all of the associated pixels for downstream processing, exhibiting an overall slower sequential process. The event detection pixel sensor circuit assembly 10, in contrast, is able to transmit only movements and their coordinates for downstream processing, providing a much faster overall processing speed.

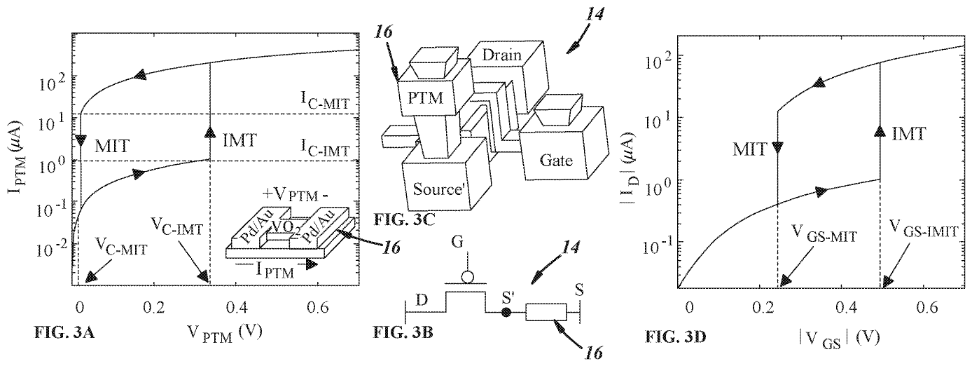

As set forth, the event detection pixel sensor circuit assembly 10 and the HyperFET 14 have the PTM 16 in its design and construction. Phase transition materials, in general, are a class of materials characterized by abrupt changes in resistivity, and can undergo transitions that are triggered by various stimuli. The PTM 16 of the HyperFET 14 is triggered by electrical stimuli. In this embodiment, the PTM 14 is composed of a vanadium dioxide (VO₂) based material, but could be composed of other materials in other embodiments. An embodiment of the PTM 16 and its structure is presented as an inset in FIG. 3(a) in the lower righthand corner of the graph. At lower voltages, the PTM 16 typically remains in a high-resistance or insulating state. But upon application of a higher voltage greater than a critical voltage value (V_{C-IMT}) and critical current value (I_{C-IMT}), an insulator-to-metal transition (IMT) takes place (see the graph of FIG. 3(a)), and the corresponding current density is called J_{C-IMT}. In other words, the PTM 16 switches states. In its insulating state, the PTM 16 exhibits a resistivity (ρINs) that is orders of magnitude greater than that of its metallic or metal state (ρM). Conversely, when the voltage is reduced to a sufficiently low level (V_{C-MIT}), the PTM 16 undergoes a metal-to-insulator transition (MIT) and state switch, and the corresponding current density is called J_{C-MIT}.

In an embodiment, the PTM 16 is integrated into a source terminal of a field-effect transistor (FET), thereby constituting the HyperFET 14. In essence, the HyperFET 14 combines the behavior of a FET with the abrupt switching property of a phase transition material (i.e., the PTM 16). At lower |V_{GS}|, the FET is off and the PTM 16 remains in the high resistance state (HRS), effectively behaving like an extremely high resistance at the source terminal, and thereby reducing an off-current (I_{OFF}) of the associated transistor (see FIG. 3(d)). When a gate-to-source voltage |V_{GS}| crosses a critical voltage (|V_{GS-IMT}|), the PTM 16 undergoes an IMT transition and state switch, eventually acting as a very low resistance at the source terminal. Conversely, when the gate-to-source voltage |V_{GS}| is reduced to a sufficiently low level (|V_{GS-MIT}|), the PTM 16 undergoes a metal-to-insulator transition (MIT) and state switch and again goes to the HRS; in other words, the PTM 16 reverts to its insulating state.

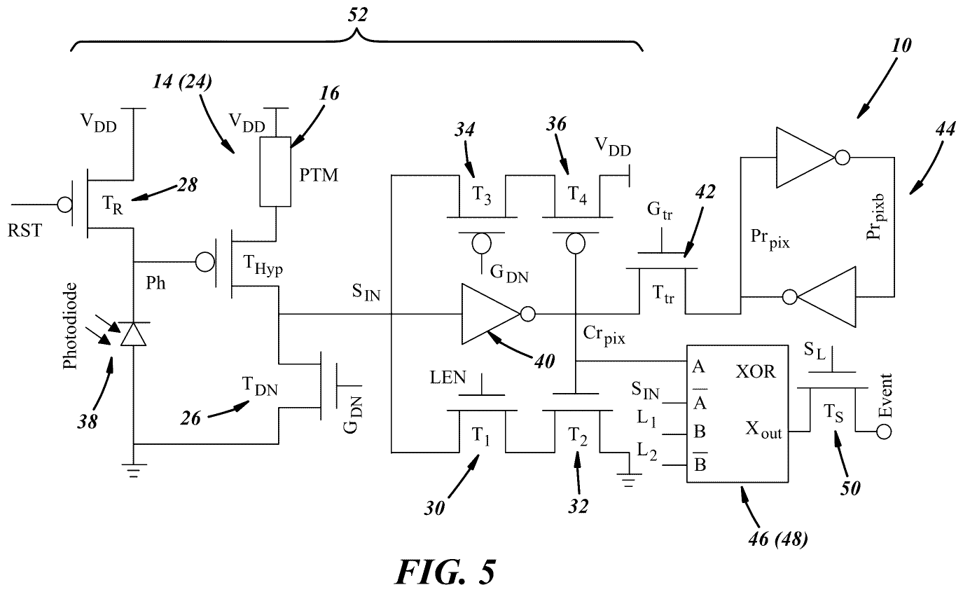

The event detection pixel sensor circuit assembly 10 can have various designs, constructions, and components in various embodiments. In the embodiment of FIG. 5, the event detection pixel sensor circuit assembly 10 includes a first transistor 24 (PTM & T_{Hyp}, or the HyperFET 14 with the PTM 16), a second transistor (T_{DN}) 26, a third or reset transistor (T_{R}) 28, a fourth or latch enabler transistor (T₁) 30, a fifth transistor (T₂) 32, a sixth transistor (T₃) 34, a seventh transistor (T₄) 36, a photodiode 38, an inverter 40, an eighth or transfer transistor (Tₜᵣ) 42, a cross-coupled inverter 44, an exclusive OR (XOR) logic gate circuit assembly 46 (which, in this embodiment, takes the form of a complementary metal-oxide-semiconductor (CMOS) XOR logic gate circuit assembly 48, and an eight transistor CMOS circuit), and a ninth transistor (T_{S}) 50; still, the event detection pixel sensor circuit assembly 10 could have more, less, and/or different components in different embodiments. Certain of these components of the event detection pixel sensor circuit assembly 10 can establish a binary pixel sensor circuit assembly 52. In this embodiment, the first transistor 24, second transistor 26, reset transistor 28, latch enabler transistor 30, fifth transistor 32, sixth transistor 34, seventh transistor 36, photodiode 38, and inverter 40 are all components of the binary pixel sensor circuit assembly 52 and form that assembly. Indeed, the region and components of the event detection pixel sensor circuit assembly 10 that make-up the binary pixel sensor circuit assembly 52 are described in U.S. patent application publication number 2025/0338037 having a publication date of Oct. 30, 2025, owned by the University of Tennessee Research Foundation, the present applicant, and the contents of which are hereby incorporated herein in their entirety by reference.

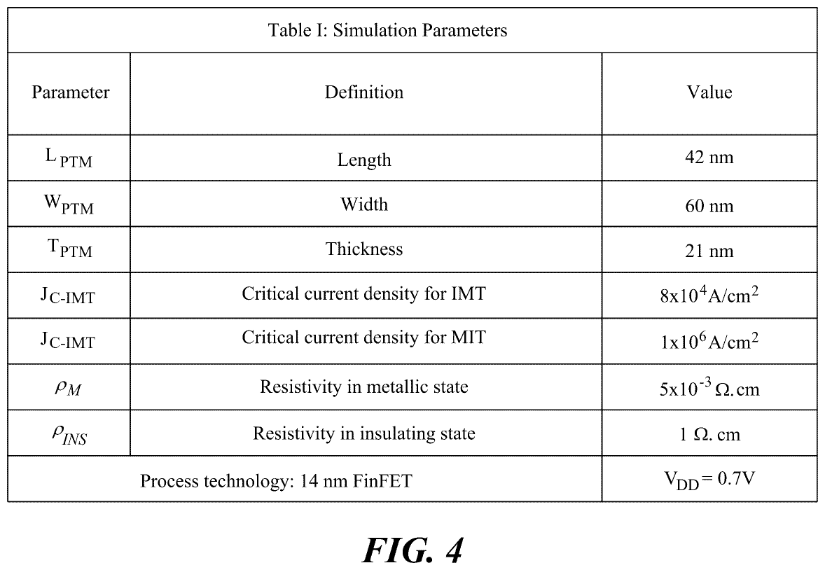

The components of the event detection pixel sensor circuit assembly 10 can reside on one or more substrates and possess electrical communication and coupling with one another. According to the embodiment of FIG. 5, for example, the reset transistor 28 and HyperFET 14 are in immediate electrical communication and coupling with each other; and the HyperFET 14 and second transistor 26 are in immediate electrical communication and coupling with each other. Further, the transfer transistor 42 is configured in downstream electrical communication and coupling relative to the binary pixel sensor circuit assembly 52; the cross-coupled inverter 44 is configured in downstream electrical communication and coupling relative to the binary pixel sensor circuit assembly 52 and relative to the transfer transistor 42; the XOR logic gate circuit assembly 46 is configured in downstream electrical communication and coupling relative to the binary pixel sensor circuit assembly 52; and the ninth transistor 50 is configured in downstream electrical communication and coupling relative to the binary pixel sensor circuit assembly 52 and relative to the XOR logic gate circuit assembly 46. Still, other relative configurations are possible in other embodiments. The cross-coupled inverter 44 has a pair of inverters interconnected in a loop, as depcited. Further, the circuit simulation software known as HSPICE was used to simulate operation of the event detection pixel sensor circuit assembly 10. Parameters of the PTM 16 that were used in the simulation are presented in the table of FIG. 4; still, other parameters can be used in other simulations, as well as other simulation software, which could yield various results.

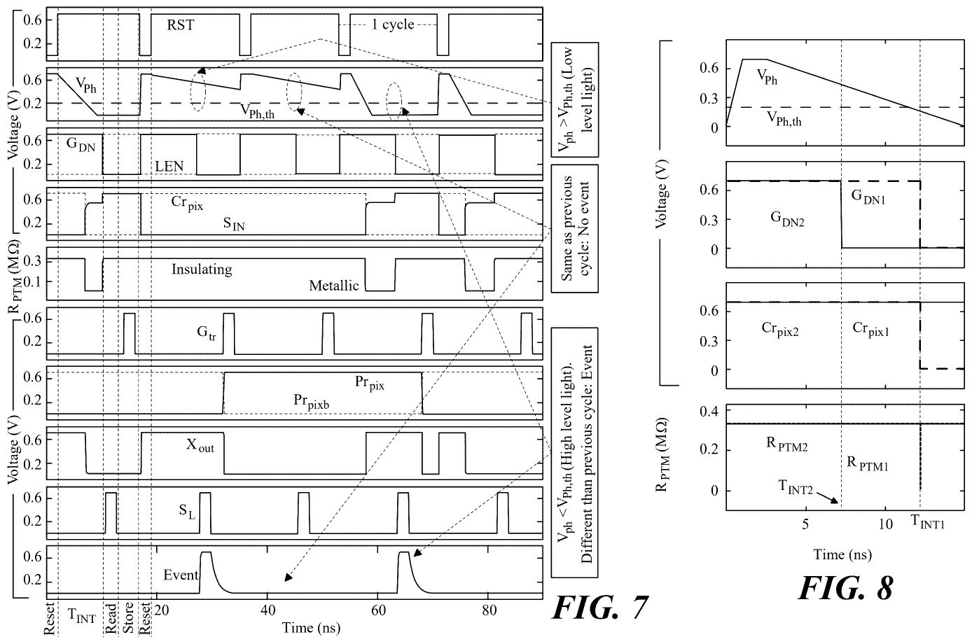

The circuit design and configuration of the event detection pixel sensor circuit assembly 10 has been shown to be in somewhat natural alignment with operating principles of the HyperFET 14, according to the embodiment of FIG. 5. An operation cycle of the event detection pixel sensor circuit assembly 10 consists of four operational phases: a reset phase, a light integration phase, a read phase, and a store phase. These operational phases are demonstrated in the graphs of FIG. 7. The photodiode node (Ph) is set to a supply voltage V_{DD} by activating the reset transistor 28 in the reset phase. In the light integration phase, a photodiode voltage VPh drops due to photocurrent generated by incident light and illumination. The photodiode voltage Vph drop is proportional to the incident light level. V_{DD}-V_{Ph} works as the |V_{GS}| of the HyperFET 14 and when it crosses the |V_{GS-IMT}|, this specific photodiode voltage V_{Ph} is deemed the threshold photodiode (Ph) voltage (V_{Ph,th}). High incident light level is an intensity of light that causes the photodiode voltage to drop low enough to cross the threshold photodiode voltage; that is, the photodiode voltage has a value that is less than that of the threshold photodiode voltage (V_{Ph}<V_{Ph,th}). Low incident light level, in contrast, is an intensity of light in which the photodiode voltage remains above the threshold photodiode voltage; that is, the photodiode voltage has a value that is greater than that of the threshold photodiode voltage (V_{Ph}>V_{Ph,th}).

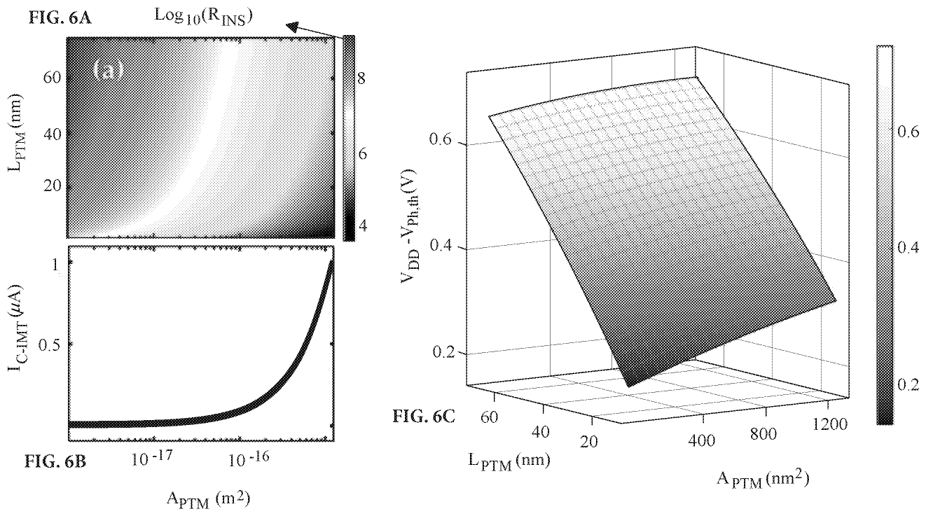

The voltage drop to reach the threshold (V_{DD}-V_{Ph,th}) can be tuned via design and construction of a geometry of the PTM 16. The graph of FIG. 6C provides a demonstration of this. The length and area of the PTM 16 control the insulating resistance (R_{INS}) and the I_{C-IMT} (see FIGS. 6A and 6B), which are parameters to tune the |V_{GS-IMT}|, per this embodiment. Further, as demonstrated by the graphs of FIGS. 6A, 6B, and 6C, a variance of the PTM geometry effects a resistance of the PTM 16, effects a current of the PTM 16, and effects the threshold photodiode voltage V_{Ph,th}.

Based on an incident light experienced by the event detection pixel sensor circuit assembly 10, the event detection pixel sensor circuit assembly 10 functions in two ways. The event detection pixel sensor circuit assembly 10 can be subject to a high incident light level or a low incident light level. At the high incident light level, the following occurs: the photodiode voltage V_{Ph} is less than the threshold photodiode voltage V_{Ph,th} (i.e., V_{Ph}<V_{Ph,th}), an insulator-to-metal state switch occurs at the PTM 16 of the HyperFET 14, the second transistor 26 is deactivated and in an off state, the latch enabler transistor 30 is activated and in an on state, a sense in a node (S_{IN}) goes to a high state, and a node that stores a current pixel voltage value Crₚᵢₓ goes to a low state. Furthermore, at the low incident light level, the following occurs: the photodiode voltage Vₚₕ is greater than the threshold photodiode voltage V_{Ph,th} (i.e., V_{Ph}>V_{Ph,th}), an insulator-to-metal state switch does not occur at the PTM 16 of the HyperFET 14 (i.e., the PTM 16 remains in its insulating state), the second transistor 26 is deactivated and in its off state, the latch enabler transistor 30 is activated and in its on state, a sense in the node S_{IN} remains in a low state, and the current pixel voltage value Crₚᵢₓ goes to a high state. The current pixel voltage value Crₚᵢₓ is received by the cross-coupled inverter 44. In this embodiment, the transfer transistor 42 transfers the current pixel voltage value Crₚᵢₓ to the cross-coupled inverter 44. The cross-coupled inverter 44 stores a previous pixel voltage value Prₚᵢₓ and its complementary Pr_{pixb} amid the store phase. The previous pixel voltage value Prₚᵢₓ is used in a subsequent operation cycle of the event detection pixel sensor circuit assembly 10.

Further, in the subsequent operation cycle of the event detection pixel sensor circuit assembly 10, after the reset phase and light integration phase, the values of Crₚᵢₓ and Prₚᵢₓ are compared in the XOR logic gate circuit assembly 46. The XOR logic gate circuit assembly 46, per this embodiment calls for two inputs and their complementary signals. The event detection pixel sensor circuit assembly 10 has the two complementary signals readily available (i.e., S_{IN} and Pr_{pixb}). If the previous operation cycle's previous pixel voltage value Prₚᵢₓ does not match, and lacks correspondence with respect to, the current pixel voltage value Crₚᵢₓ, then an event occurrence is deemed to have been established (can be called “Event”) and an output of the XOR logic gate circuit assembly 46 (Xₒᵤₜ) becomes high; otherwise, when the previous operation cycle's previous pixel voltage value Prₚᵢₓ matches and corresponds with the current pixel voltage value Crₚᵢₓ, the output of the XOR logic gate circuit assembly 46 (Xₒᵤₜ) is low. The Xₒᵤₜ value, after the light integration phase and before the store phase, indicates whether an “Event” occurred or not. Moreover, the ninth transistor 50 with a gate signal S_{L} transfers this specific time's Xₒᵤₜ to a final node Event. In the graphs of FIG. 7: 1^{st} to 2^{nd}, 2^{nd} to 3^{rd}, 3^{rd} to 4^{th}, and 4^{th} to 5^{th} operation cycle transitions show high incident light level (H) to low incident light level (L), L to L, L to H, and H to H transitions, respectively. The Event becomes high only when H to L or L to H operation cycle transitions occur.

With reference now to the graphs of FIG. 8, to enable dynamic thresholding-decision tuning, an integration time (T_{INT}) of the integration phase can be varied. FIG. 5 shows two different T_{INTS}. In a first scenario (i.e., 1^{st} case), a first integration time period T_{INT1} is large, the photodiode voltage V_{Ph} crosses the threshold photodiode voltage V_{Ph,th}, which is treated as a high incident light level. In a second scenario (i.e., 2^{nd} case), for the same level of incident light, within a second integration time period T_{INT2} (here, T_{INT2} is less than T_{INT1}), the photodiode voltage Vₚₕ does not cross the threshold photodiode voltage V_{Ph,th}, which is treated as a low incident light level. Here, the integration time period of the integration phase of the event detection pixel sensor circuit assembly 10 is variable with respect to the photodiode voltage Vₚₕ, while the threshold photodiode voltage V_{Ph,th} remains at a substantially constant value. Accordingly, timing can be a tuning knob to vary the thresholding functionality.

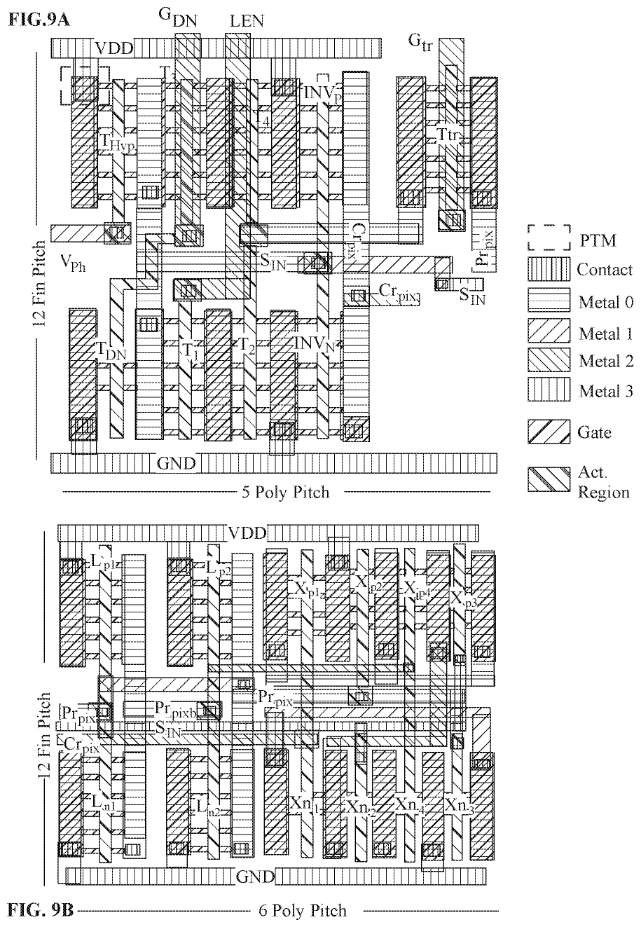

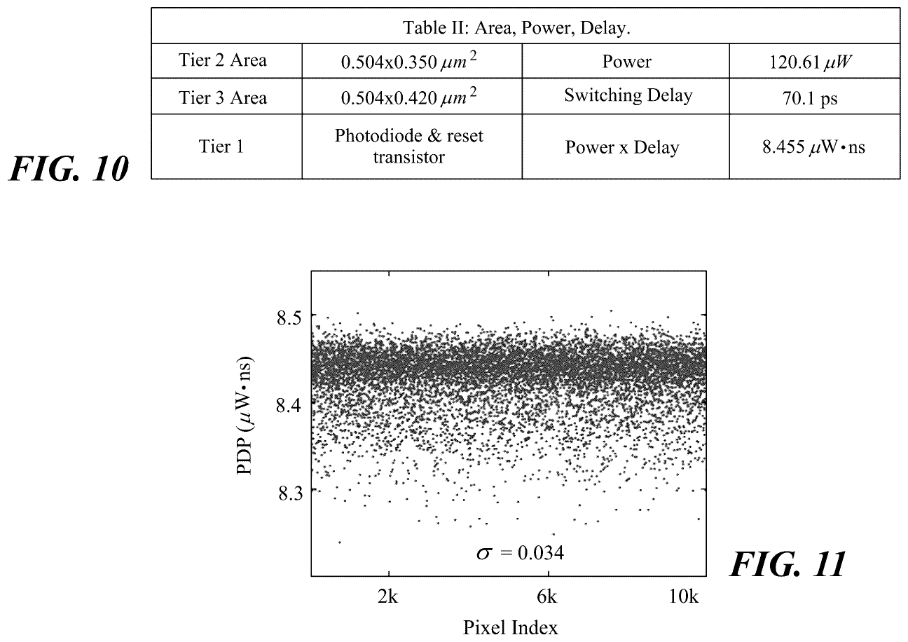

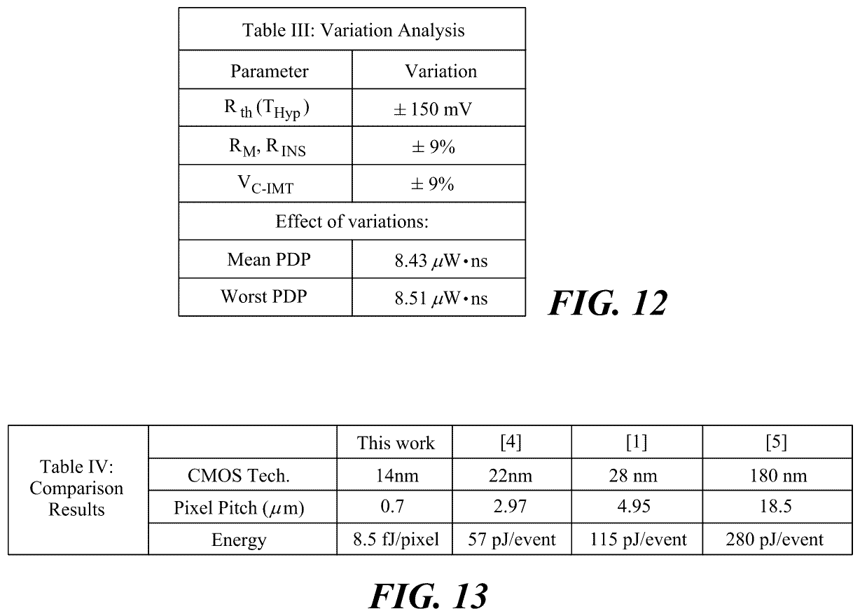

With reference now to the schematic stick diagrams of FIGS. 9A and 9B, the event detection pixel sensor circuit assembly 10 and image sensor 12 can exhibit a stacked configuration according to this embodiment. The stacked configuration includes a first tier and layer, a second tier and layer, and a third tier and layer. The event detection pixel sensor circuit assembly 10 is divided into three parts to implement such a 3-tier stacked image sensor. The reset transistor 28 and the photodiode 38 can reside at, and be situated on, the first tier. The HyperFET 14, second transistor 26, latch enabler transistor 30, fifth transistor 32, sixth transistor 34, seventh transistor 36, inverter 40, and the transfer transistor 42 reside at, and be situated on, the second tier. Lastly, according to this embodiment, the cross-coupled inverter 44 and the XOR logic gate circuit assembly 46 reside at, and be situated on, the third tier. FIG. 9A illustrates the second tier, and FIG. 9B illustrates the third tier. In Table II of FIG. 10, estimations of area, power, and switching delay of the first tier, second tier, and third tier are presented. In particular, the areas of the second and third tiers are estimated using the schematic stick diagrams of FIGS. 9A and 9B. Further, a maximum dimension of the first tier is 0.647 μm, which determines an overall pixel-pitch since the maximum dimensions of the second and third tiers are lower. The switching delay of Table II was measured as the time interval between the photodiode voltage V_{Ph} crossing the threshold photodiode voltage V_{Ph,th} and the fifty percent (50%) fall or rise (0.35V) of the Xₒᵤₜ signal. The power of Table II was calculated by averaging the instantaneous power during the periods when current flows from V_{DD}. To analyze the pixel-to-pixel process variation effect, a 10000 points Monte Carlo simulation was performed, as shown in FIG. 11. A comparison of the event detection pixel sensor circuit assembly 10 (denoted “This work”) with certain past event detection pixel sensors (denoted “[4]” and “[1]” and “[5]”) is shown Table IV of FIG. 13. The energy of the event detection pixel sensor circuit assembly 10 is presented in fJ/pixel unit since the overall energy will depend on the array size.

In general, while a multitude of embodiments have been depicted and described with a multitude of components and steps in each embodiment, in alternative embodiments the components and steps of various embodiments could be intermixed, combined, and/or exchanged for one another. In other words, components described in connection with a particular embodiment are not necessarily exclusive to that particular embodiment.

As used herein, the terms “general” and “generally” and “substantially” are intended to account for the inherent degree of variance and imprecision that is often attributed to, and often accompanies, any design and manufacturing process, including engineering tolerances—and without deviation from the relevant functionality and intended outcome—such that mathematical precision and exactitude is not implied and, in some instances, is not possible. In other instances, the terms “general” and “generally” are intended to represent the inherent degree of uncertainty that is often attributed to any quantitative comparison, value, and measurement calculation, or other representation.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. An event detection pixel sensor circuit assembly for an image sensor, the circuit assembly comprising:
a reset transistor and a first transistor and a second transistor in electrical communication with one another, said first transistor being a hybrid phase transition field-effect transistor (HyperFET) having a phase transition material (PTM) at a source terminal thereof;
a cross-coupled inverter in downstream electrical communication with said first transistor and said second transistor; and
an exclusive OR (XOR) logic gate circuit assembly in electrical communication with said cross-coupled inverter;
wherein, amid operation of the event detection pixel sensor circuit assembly, a state of said phase transition material of said hybrid phase transition field-effect transistor switches when a photodiode voltage of a photodiode of the event detection pixel sensor circuit assembly is less than a threshold photodiode voltage due to an incident light level at the photodiode.

2. The event detection pixel sensor circuit assembly as set forth in claim 1, wherein, amid operation of the event detection pixel sensor circuit assembly, a current pixel voltage value is received by said cross-coupled inverter, and said cross-coupled inverter stores a previous pixel voltage value.

3. The event detection pixel sensor circuit assembly as set forth in claim 2, wherein, amid operation of the event detection pixel sensor circuit assembly, said current pixel voltage value is compared to said previous pixel voltage value via said exclusive OR logic gate circuit assembly.

4. The event detection pixel sensor circuit assembly as set forth in claim 3, wherein, amid operation of the event detection pixel sensor circuit assembly, upon comparison of said current pixel voltage value and said previous pixel voltage value, when said current pixel voltage value and said previous pixel voltage value lack correspondence with respect to each other, an output of said exclusive OR logic gate circuit assembly establishes an event occurrence.

5. The event detection pixel sensor circuit assembly as set forth in claim 2, further comprising a transfer transistor in electrical communication with said cross-coupled inverter, and wherein, amid operation of the event detection pixel sensor circuit assembly, said current pixel voltage value is transferred to said cross-coupled inverter via said transfer transistor.

6. The event detection pixel sensor circuit assembly as set forth in claim 1, further comprising a latch enabler transistor and wherein, amid operation of the event detection pixel sensor circuit assembly, at a high incident light level, said photodiode voltage is less than said threshold photodiode voltage, an insulator-to-metal state switch occurs at said phase transition material of said hybrid phase transition field-effect transistor, said second transistor is deactivated, said latch enabler transistor is activated, and a current pixel voltage value received by said cross-coupled inverter is at a low state.

7. The event detection pixel sensor circuit assembly as set forth in claim 1, further comprising a latch enabler transistor and wherein, amid operation of the event detection pixel sensor circuit assembly, at a low incident light level, said photodiode voltage is greater than said threshold photodiode voltage, said phase transition material of said hybrid phase transition field-effect transistor remains in an insulating state, said second transistor is deactivated, said latch enabler transistor is activated, and a current pixel voltage value received by said cross-coupled inverter is at a high state.

8. The event detection pixel sensor circuit assembly as set forth in claim 1, wherein said phase transition material of said hybrid phase transition field-effect transistor exhibits a phase transition material geometry, and a variance of said phase transition material geometry effects a resistance of said phase transition material, effects a current of said phase transition material, and effects said threshold photodiode voltage.

9. The event detection pixel sensor circuit assembly as set forth in claim 1, wherein, amid operation of the event detection pixel sensor circuit assembly, an integration time period of a light integration phase of the event detection pixel sensor circuit assembly is variable with respect to said photodiode voltage while said threshold photodiode voltage remains substantially constant.

10. The event detection pixel sensor circuit assembly as set forth in claim 1, further comprising a latch enabler transistor and an inverter, and wherein said reset transistor, said first transistor, said second transistor, said latch enabler transistor, and said inverter constitute at least some components of a binary pixel sensor circuit assembly.

11. The event detection pixel sensor circuit assembly as set forth in claim 1, wherein the event detection pixel sensor circuit assembly is an in-pixel event detection pixel sensor circuit assembly in which said in-pixel event detection pixel sensor circuit assembly resides within a single pixel of an image sensor pixel array.

12. The event detection pixel sensor circuit assembly as set forth in claim 1, wherein said XOR logic gate circuit assembly is a complementary metal-oxide-semiconductor (CMOS) XOR logic gate circuit assembly.

13. An image sensor comprising a plurality of pixels, at least some of said plurality of pixels having a dedicated event detection pixel sensor circuit assembly as set forth in claim 1 residing therein.

14. The image sensor as set forth in claim 13, wherein the image sensor exhibits a stacked configuration comprising a first tier, a second tier, and a third tier, said reset transistor and the photodiode situated at said first tier, said first transistor and said second transistor situated at said second tier, and said cross-coupled inverter and said exclusive OR logic gate circuit assembly situated at said third tier.

15. An event detection pixel sensor circuit assembly for an image sensor, the circuit assembly comprising:
a binary pixel sensor circuit assembly comprising a reset transistor and a first transistor and a second transistor in electrical communication with one another, said first transistor being a hybrid phase transition field-effect transistor (HyperFET) having a phase transition material (PTM) at a source terminal thereof;
a cross-coupled inverter in electrical communication with said binary pixel sensor circuit assembly; and
a complementary metal-oxide-semiconductor (CMOS) exclusive OR (XOR) logic gate circuit assembly in electrical communication with said cross-coupled inverter;
wherein, amid operation of the event detection pixel sensor circuit assembly, a current pixel voltage value is received by said cross-coupled inverter and a previous pixel voltage value is stored by said cross-coupled inverter, said current pixel voltage value is compared to said previous pixel voltage value via said CMOS XOR logic gate circuit assembly and, when said current pixel voltage value and said previous pixel voltage value lack correspondence with respect to each other, an output of said CMOS XOR logic gate circuit assembly establishes an event occurrence.

16. The event detection pixel sensor circuit assembly as set forth in claim 15, further comprising a latch enabler transistor and wherein, amid operation of the event detection pixel sensor circuit assembly, at a high incident light level, a photodiode voltage is less than a threshold photodiode voltage, an insulator-to-metal state switch occurs at said phase transition material of said hybrid phase transition field-effect transistor, said second transistor is deactivated, said latch enabler transistor is activated, and a current pixel voltage value received by said cross-coupled inverter is at a low state.

17. The event detection pixel sensor circuit assembly as set forth in claim 16, wherein, amid operation of the event detection pixel sensor circuit assembly, at a low incident light level, said photodiode voltage is greater than said threshold photodiode voltage, said phase transition material of said hybrid phase transition field-effect transistor remains in an insulating state, said second transistor is deactivated, said latch enabler transistor is activated, and said current pixel voltage value received by said cross-coupled inverter is at a high state.

18. The event detection pixel sensor circuit assembly as set forth in claim 17, wherein, amid operation of the event detection pixel sensor circuit assembly, an integration time period of a light integration phase of the event detection pixel sensor circuit assembly is variable with respect to a photodiode voltage while a threshold photodiode voltage remains substantially constant.

19. An event detection pixel sensor circuit assembly for an image sensor, the circuit assembly comprising:
a reset transistor and a first transistor and a second transistor in electrical communication with one another, said first transistor being a hybrid phase transition field-effect transistor (HyperFET) having a phase transition material (PTM) at a source terminal thereof;
a cross-coupled inverter in electrical communication with said first transistor and said second transistor;
an exclusive OR (XOR) logic gate circuit assembly in electrical communication with said cross-coupled inverter; and
a transfer transistor in electrical communication with said cross-coupled inverter;
wherein, amid operation of the event detection pixel sensor circuit assembly, a current pixel voltage value is transferred to said cross-coupled inverter via said transfer transistor, a previous pixel voltage value is stored by said cross-coupled inverter, said current pixel voltage value is compared to said previous pixel voltage value via said XOR logic gate circuit assembly and, when said current pixel voltage value and said previous pixel voltage value lack correspondence with respect to each other, an output of said XOR logic gate circuit assembly establishes an event occurrence; and
wherein, amid operation of the event detection pixel sensor circuit assembly, an integration time period of a light integration phase of the event detection pixel sensor circuit assembly is variable with respect to a photodiode voltage of a photodiode of the event detection pixel sensor circuit assembly while a threshold photodiode voltage remains substantially constant.

20. The event detection pixel sensor circuit assembly as set forth in claim 19, further comprising a latch enabler transistor;
wherein, amid operation of the event detection pixel sensor circuit assembly, at a high incident light level, said photodiode voltage is less than said threshold photodiode voltage, an insulator-to-metal state switch occurs at said phase transition material of said hybrid phase transition field-effect transistor, said second transistor is deactivated, said latch enabler transistor is activated, and a current pixel voltage value received by said cross-coupled inverter is at a low state; and
wherein, amid operation of the event detection pixel sensor circuit assembly, at a low incident light level, said photodiode voltage is greater than said threshold photodiode voltage, a metal-to-insulator state switch occurs at said phase transition material of said hybrid phase transition field-effect transistor, said second transistor is deactivated, said latch enabler transistor is activated, and a current pixel voltage value received by said cross-coupled inverter is at a high state.
